(19) United States
(12) Patent Application Publication
(10) Pub. No.: US 2012/0160371 A1
(43) Pub. Date: Jun. 28, 2012

(54) Flail Chain for Use in Debarking Trees

(75) Inventors: Jinhuan Huangfu, Rossmoyne (AU); Phillip Morris Dohnt, Penola (AU)

(73) Assignee: FUNCTION CHAIN PTY, LTD., Rossmoyne (AU)

(21) Appl. No.: 13/410,871

(22) Filed: Mar. 2, 2012

Related U.S. Application Data
(63) Continuation-in-part of application No. 12/692,927, filed on Jan. 25, 2010.

(30) Foreign Application Priority Data
Feb. 25, 2009 (AU) 2009200745

(51) Int. Cl. B27L 1/12; F16G 13/18; B27L 1/10

(52) U.S. Cl. 144/208.7; 59/90; 59/78

(57) ABSTRACT

A link for debarking trees comprising at least two linear sides, each linear side having an outer surface, an inner surface and a diameter; and at least two opposing deformed sides, each deformed side having an outer surface, an inner surface, an undeformed diameter, and a deformation having a diameter different than the undeformed diameter; the at least two opposing deformed sides connected to the at least two linear sides through convex corner sections, such that the inner surfaces of the at least two opposing deformed sides and the inner surfaces of the at least two linear sides together form an interior space. Multiple links may be arranged into a chain and the chain may be used in a flailing apparatus.

### REFERENCE TO RELATED APPLICATIONS

The application is a continuation-in-part of patent application Ser. No. 12/692,927, filed Jan. 25, 2010, entitled, “FLAIL CHAIN FOR USE IN DEBARKING TREES”, which claims priority from Australian application no. 2009200745 filed Feb. 25, 2009, entitled, “FLAIL CHAIN FOR USE IN DEBARKING TREES”. The aforementioned application(s) are hereby incorporated herein by reference.

### BACKGROUND OF THE INVENTION

1. Field of the Invention

The present invention broadly relates to a flail chain for use in debarking trees.

2. Description of Related Art

Bark needs to be removed from felled trees prior to the process of wood chipping. An apparatus commonly used for debarking trees is a flailing apparatus comprising a rotatable drum with a plurality of flail chains, each having one end fixed to the rotatable drum. Generally the flail chain comprises a plurality of substantially oblong shaped linkage elements.

During the debarking process, minor wear is caused to external surfaces of the linkage elements of the flail chains as they strike the tree bark. Significant wear occurs on internal surfaces of the linkage elements, particularly in opposing end regions where adjacent chain linkage elements engage with one another.

As a result of the aforementioned wear, flail chains must be regularly replaced. Consequently, the replacement of flail chains results in high capital expenditure and, by necessity, lost productivity in down time.

Square or diamond shaped links for chains are not new. For example, U.S. Pat. No. 3,794,096, entitled “Web Link for Tire Anti-Skid Chains” discloses a web link for anti-skid tire chains. The links are generally square with sides that are substantially the same length. The link defines a receiving opening that may be diamond shaped or circular. The receiving openings each have concavely curved corner sections to form individual areas for receiving connecting links.

U.S. Pat. No. 3,072,170, entitled, “Tire Chain” discloses a diamond shaped link used with tire chains. The cross-sectional diameter of the links is constant.

U.S. Pat. No. 7,878,227, entitled “Debarking Chain with Passing Links” discloses a square shaped link defining an interior space, where the cross-sectional diameter of the link is constant.

U.S. Pat. No. 3,427,801, entitled, “Cast Chains” discloses a method of casting metal chains. Some of the links are cast as open and are welded closed onto closed casted links.

### SUMMARY OF THE INVENTION

A link for debarking trees comprising at least two linear sides, each linear side having an outer surface, an inner surface and a diameter; and at least two opposing deformed sides, each deformed side having an outer surface, an inner surface, an undeformed diameter, and a deformation having a diameter different than the undeformed diameter; the at least two opposing deformed sides connected to the at least two linear sides through convex corner sections, such that the inner surfaces of the at least two opposing deformed sides and the inner surfaces of the at least two linear sides together form an interior space. Multiple links may be arranged into a chain and the chain with links of the present invention may be used in a flailing apparatus.

While only two sides are shown as having deformations, any side or all sides of the link may be formed with deformations within the scope of the invention.

### BRIEF DESCRIPTION OF THE DRAWING

FIG. 1 shows a front view of a link for a flail chain of a first embodiment of the present invention.

FIG. 2 shows a cross-sectional view of the link along line 2-2 of FIG. 1.

FIG. 3 shows a cross-sectional view of the link along line 3-3 of FIG. 1.

FIG. 4 shows a front view of a flail chain including a link of a first embodiment of the present invention.

FIG. 5 shows an isometric view of a flail chain device in accordance of a first embodiment of the present invention.

FIG. 6 shows a front view of a link for a flail chain of a second embodiment.

FIG. 7 shows a front view of a link for a flail chain of a third embodiment.

### DETAILED DESCRIPTION OF THE INVENTION

FIG. 1 shows a link of an embodiment of the present invention. The link 10 of the present invention is a generally square shape with four sides 12, 14 of substantially identical length and arranged at approximately right angles with regard to each other. Each of the four sides has an inner surface 12b, 14b, and an outer surface 12a, 14a.

Two sides 12 oppose each other and are linear, the other two sides 14 oppose each other and are deformed by deformations 16 and 18. The deformations may include, but are not limited to, a pressed portion 16 and a weld 18, as shown in FIGS. 1-3. The two linear sides 12 are connected to the two deformed sides 14 by convex corner sections 26 having an outer curve 26a and an inner curve 26b. The sides 12, 14 are generally straight, but might be formed with a degree of curvature within the teachings of the invention. The inner surfaces 12b, 14b of the sides 12, 14 of the link and the inner surfaces of the convex corner sections 26b define an interior space 24 of the link 10.

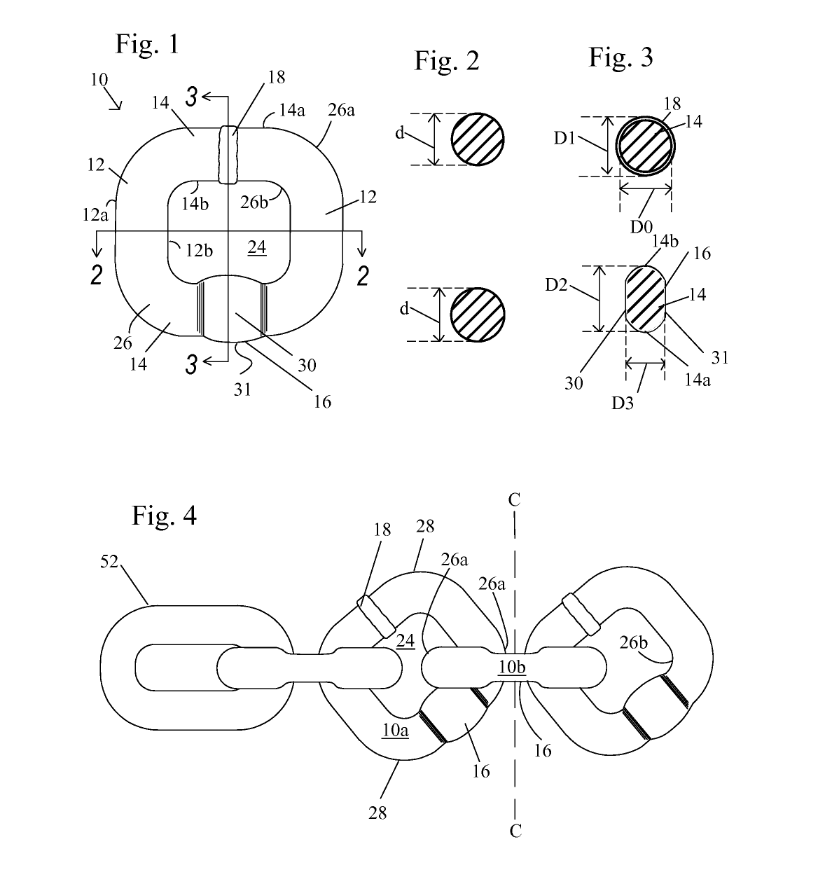

The diameter d of the linear sides 12 is generally constant along the side, as is shown in FIG. 2, a section cut along line 2-2 in FIG. 1.

On the deformed sides 14, the deformation alters the diameter DO of the deformed sides 14 as shown in FIG. 3, a cut-through along lines 3-3 in FIG. 1. One of the deformed sides 14 includes a weld 18 which has a thicker cross-section D1 than the cross-sectional diameter D0 of the undeformed portion of the side 14. The other of the deformed sides 14 includes a pressed portion 16, in which the generally round shape of the side 14 of diameter D0 is pressed on an upper surface 30 and lower surface 31 to a reduced thickness D3. This pressing results in a thicker cross-sectional diameter D2 between the inside 14b and outside 14a of the side 14. The undeformed diameter D0 of sides 14 may be the same as diameter d of sides 12, but such equality is not required.

The pressing portion 16 is of the link is preferably made by applying a pressure to both sides of the link of approximately 30 tons. It is also preferable if the pressed length of the pressed portion 16 is approximately 65% of the length of one side of the link or may be 16% of the total length of the sides of the link.

While a generally square link is shown, any link with an even number of sides in which at least two of the sides oppose each other and include deformations that are directly opposite each other may also be used within the scope of the invention. While only two sides are shown as having deformations, all sides of the link may be formed with deformations within the scope of the invention.

The link shape need not be square. As a further example, a generally hexagonal shaped link is shown in FIG. 6, and a generally octagonal one in FIG. 7. In FIG. 6, there are four linear sides 62 of the hexagonal link 60, and two deformed sided 64, opposed to each other, having weld 66 and pressing 68. In FIG. 7, octagonal link 70 has six linear sides 72 and two deformed sided 74, opposed to each other, having weld 76 and pressing 78.

Furthermore, regardless of the number of sides of the link, it is preferable that all of the sides are substantially the same length as one another and that sides which connected adjacently are all connected at approximately the same angle.

In use, as shown in FIG. 4, a plurality of links 10 are arranged to be sequentially linked with one another, thereby forming a flail chain 50. Each link 10 is arranged to be linked to two opposing adjacent links 10. It will be appreciated that the chain may also include one or more prior art oblong link 52, in addition to the links 10.

Adjacent links 10a, 10b are linked together in an arrangement, such that an outer convex corner section 26a of link 10b is within the interior space 24 and may engage the interior convex corner section 26b defined by link 10a when the links 10a, 10b are placed under opposing tensions. If the interior convex corner section 26b is adjacent the pressed portion 16, the outer convex corner section 26 of link 10b may also engage a portion of an interior surface 14b of the pressed portion 16. At the same time, the outer convex corner section 26a of link 10a is within the interior space 24 and may engage the interior convex corner section 26b defined by link 10a, when the links 10a, 10b are placed under opposing tensions.

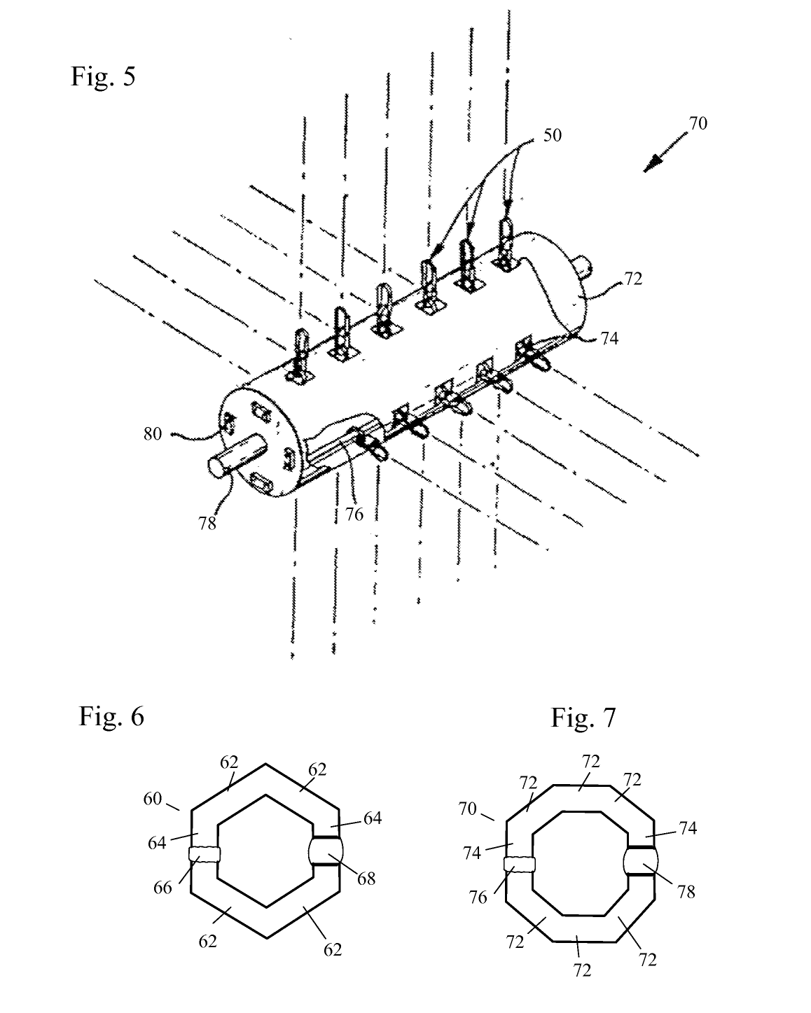

In the embodiment shown in FIG. 4, two of the opposing convex corner sections (in FIG. 4 labeled as reference number 28) remain unengaged by the adjacent links. Furthermore, the two unengaged opposing outer convex corner sections 28 of each link 10a, 10b, along with the pressed portion 16 and the weld 18 protrude outwardly from the flail chain 50. In use, the unengaged outwardly protruding outer corners 28 strike the tree and therefore assist in flailing and removing bark from the tree as well as the additional surface area provided by the pressed portion 16 and the weld 18 of the link. The unengaged outwardly protruding outer corners 28 thus contribute to the flailing efficiency of both the flail chains 50 and a flailing apparatus 70, such as shown in FIG. 5, that employs a plurality of flail chains 50 of the present invention.

When linked together as described above, the interior space 24 of the links 10 facilitates rotation of the link 10 about a respective central longitudinal axis C, such that there may be a period in which the unengaged convex corner sections (indicated by reference number 28 in FIG. 4) are engaged with adjacent convex corner sections 26b, and the engaged convex corner sections (indicated by reference number 26, 26a, 26b in FIG. 4) become disengaged from one another and protrude outwardly from the flail chain 50.

Over time, the ability of the link 10 to rotate about its central longitudinal axis C ensures that any one of the convex corner sections 26 is likely to be disposed for a similar period of time in an engaged location as in an unengaged location 28 in the flail chain 50. It follows that frictional wear on the external surface 12a, 14a of the link 10 caused by the flail chain 50 striking trees, although minor, is likely to be evenly distributed. The more frictional wear on the internal perimeter 20 of the link 10, particularly in the internal corner sections 26b which bear against one another when adjacent convex corner sections are mutually engaged is likely to be evenly distributed because each convex corner sections 26b spends a similar period in the engaged and unengaged locations in the flail chain 50. It should be noted that while the wear is evenly distributed, the larger cross-sectional diameter D1, D2, D3 that is caused by the deformations in two of the sides 14 of the link 10 will be maintained as being larger than the diameter d of the other sides 12 of the link 10.

As the frictional wear is distributed over more than two convex corner sections 26, the period of wear is effectively lengthened in comparison with prior art links where only two engaging portions of the linkage element are available for mutual engagement with adjacent links at any one time.

Referring now to FIG. 5 there is shown a flailing apparatus 70. Flailing apparatus 70 comprises a rotatable drum 72 having a plurality of apertures of 74. A rod 76 extends longitudinally through the drum 72 and is positioned radially inwardly of the plurality of apertures 74. A plurality of flail chains 50, each having a first end fixed to a rod 76, extend outwardly through respective apertures 74. In this example an oblong linkage element 52 is at the fixed end of each flail chain 50 and forms the connection to the rod 76. It will be appreciated however that a link 10 may be arranged at the fixed end and may be used to form the connection between the fixed end of the flail chain 50 and the rod 76.

The drum 72 further comprises a shaft 78 for engaging with a drive so as to rotate the drum. The rotatable drum further comprises access holes 80 for accessing the rod 76 for maintenance purposes and the like.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A link for a flail chain for debarking trees comprising:
at least two linear sides, each linear side having an outer surface, an inner surface and a diameter; and
at least two opposing deformed sides, each deformed side having an outer surface, an inner surface, an undeformed diameter, and a deformation having a diameter different than the undeformed diameter;
the at least two opposing deformed sides connected to the at least two linear sides through convex corner sections, such that the inner surfaces of the at least two opposing deformed sides and the inner surfaces of the at least two linear sides together form an interior space.

2. The link of claim 1, wherein the link is generally square.

3. The link of claim 1, wherein the linear sides and the deformed sides are connected at an angle of approximately ninety degrees.

4. The link of claim 1, wherein at least one of the deformations of at least one deformed side is a weld.

5. The link of claim 1, wherein at least one of the deformations of at least one deformed side is a pressed portion.

6. A flail chain for debarking trees, the flail chain comprising a plurality of sequentially linked links, each of the links comprising:
at least two linear sides, each linear side having an outer surface, an inner surface and a diameter; and
at least two opposing deformed sides, each deformed side having an outer surface, an inner surface, an undeformed diameter, and a deformation having a diameter different than the undeformed diameter;
the at least two opposing deformed sides connected to the at least two linear sides through convex corner sections, such that the inner surfaces of the at least two opposing deformed sides and the inner surfaces of the at least two linear sides together form an interior space.

7. The chain of claim 6, wherein the link is generally square.

8. The chain of claim 6, wherein the linear sides and the deformed sides are connected at an angle of approximately ninety degrees.

9. The chain of claim 6, wherein at least one of the deformations of at least one deformed side is a weld.

10. The chain of claim 6, wherein at least one of the deformations of at least one deformed side is a pressed portion.

11. A flailing apparatus for debarking trees, the flailing apparatus comprising:
a rotatable drum having a plurality of apertures;
at least one rod extending longitudinally through the drum and being positioned radially inward of the apertures; and
a plurality of flail chains, each flail chain having a first end fixed to the at least one rod and extending outwardly through a respective aperture;
wherein at least some of the links of the plurality of flail chains comprises:
at least two linear sides, each linear side having an outer surface, an inner surface and a diameter; and
at least two opposing deformed sides, each deformed side having an outer surface, an inner surface, an undeformed diameter, and a deformation having a diameter different than the undeformed diameter;
the at least two opposing deformed sides connected to the at least two linear sides through convex corner sections, such that the inner surfaces of the at least two opposing deformed sides and the inner surfaces of the at least two linear sides together form an interior space.

12. The flailing apparatus of claim 11, wherein the link is generally square.

13. The flailing apparatus of claim 11, wherein the linear sides and the deformed sides are connected at an angle of approximately ninety degrees.

14. The flailing apparatus of claim 11, wherein at least one of deformations of at least one deformed side is a weld.

15. The flailing apparatus of claim 11, wherein at least one of the deformations of at least one deformed side is a pressed portion.
